(19) United States
(12) Patent Application Publication
(10) Pub. No.: US 2025/0018816 A1
(43) Pub. Date: Jan. 16, 2025

(54) METHOD FOR OPERATING A CHARGING STATION, CONTROL DEVICE FOR CARRYING OUT SUCH A METHOD AND CHARGING STATION WITH SUCH A CONTROL DEVICE

(71) Applicant: ads-tec Energy GmbH, Nürtingen (DE)

(72) Inventors: Simon BAREIß, Rudersberg (DE); Jörg RAMIN, Kirchheim (DE)

(21) Appl. No.: 18/769,476

(22) Filed: Jul. 11, 2024

(30) Foreign Application Priority Data
Jul. 13, 2023 (DE) 102023118660.4

(51) Int. Cl. B60L 53/62; B60L 53/302; B60L 53/63

(52) U.S. Cl. CPC B60L 53/62; B60L 53/302; B60L 53/63

(57) ABSTRACT

A method for operating a charging station, control device for carrying out such a method and charging station with such a control device

The invention relates to a method for operating a charging station (1), in particular for electric vehicles, wherein

a load state of a climate conditioning device (7) of the charging station (1) is determined, and wherein

a charging capacity of the charging station (1) is influenced depending on the determined load state.

### CROSS REFERENCE TO RELATED APPLICATIONS

The present application claims the priority of German patent application No. 102023118660.4, filed on Jul. 13, 2023, which is expressly incorporated herein by reference in its entirety.

The invention relates to a method for operating a charging station, in particular for electric vehicles, a control device which is configured to carry out such a method, and a charging station having such a control device.

In charging stations that have an active climate conditioning device, depending on the ambient conditions and a current electrical load or a load curve, situations may arise in which predetermined temperature limits are reached for power electronics components of the charging station or-in the case of a charging station with an electrical energy storage system, in particular for intermediate buffering of electrical energy from the power grid, in particular as a “booster” for the active charging capacity-the electrical energy storage, in particular for its battery cells. In such a case, the current charging capacity must be drastically reduced or the charging process must even be interrupted completely, which is extremely disadvantageous and annoying for people or institutions who want to charge electrical components, in particular an electric vehicle, at the charging station, particularly due to the associated delays.

The object of the invention is thus to create a method for operating a charging station, in particular for electric vehicles, a control device which is configured to carry out such a method, and a charging station having such a control device, wherein the disadvantages mentioned are at least reduced, preferably do not occur.

The object is solved by providing the present technical teaching, in particular the teaching of the independent claims and the embodiments disclosed in the dependent claims and the description.

The object is solved in particular by creating a method for operating a charging station, in particular for electric vehicles, wherein a load state of a climate conditioning device of the charging station is determined, and wherein a charging capacity of the charging station is influenced depending on the determined load state. Advantageously, situations in which predetermined temperature limits are reached for power electronics components of the charging station or possibly its electrical energy storage system can be avoided if the charging capacity is-at least also-influenced depending on the load state of the climate conditioning device. At the same time, significantly more drastic reductions in charging capacity, including interruptions to the charging process, are at least advantageously reduced or preferably avoided. In conventional charging stations, the charging capacity on the one hand and the operation of the climate conditioning device on the other are typically controlled independently of each other: Critical temperature states of the power electronics are responded to by reducing the charging capacity and, independently of this, the climate conditioning device is switched off if it enters an overload state. The inventors have now recognized in particular that critical temperature states of the power electronics and thus also reductions in the charging capacity can occur precisely when the climate conditioning device reaches a capacitive limit or enters an overload state and can thus no longer provide any cooling capacity or only a greatly reduced cooling capacity. The invention is thus advantageously based on the idea of controlling the operation of the charging station in such a way that an overload state of the climate conditioning device is avoided as far as possible. In particular-as will also be explained in more detail below-the operation of the charging station with regard to the charging capacity, but advantageously also with regard to the operation of secondary consumers of the charging station, such as a display device, is aligned or coordinated with the aim of avoiding an overload state of the climate conditioning device. In this way, the operational readiness of the climate conditioning device is significantly extended compared to conventional charging stations, which means that the charging capacity has to be drastically reduced or even a charging process has to be interrupted at least less often. In particular, a less interrupted or even continuous operation of the climate conditioning device is made possible and its average cooling capacity is increased. This also increases the system availability of the charging station. This in turn increases convenience and the charging experience from the perspective of the people or institutions using the charging station. Furthermore, the service life of the climate conditioning device itself is also increased by avoiding overload states and, in particular, additional starting processes. Finally, additional component protection is realized by avoiding overtemperature.

In electrical engineering, a charging station is any device or electrical system, in particular stationary or mobile, which is used to supply energy to mobile battery-powered electrical devices, appliances, machines or motor vehicles by simple insertion or plugging them in without necessarily having to remove the drive energy storage system-such as the traction battery of an electric car. Charging stations for electric cars are sometimes also referred to as “electric charging stations” and can include a plurality of charging points. High performance charging systems or high power charging system (HPC systems) such as the combined charging system (CCS), which is widespread in Europe, are particularly well known. With generic direct current charging, direct current from the charging station is fed directly into the vehicle's battery and provided by a powerful rectifier, preferably of the charging station, from the power grid or by large buffer accumulators at solar charging stations, for example. There is a battery management system in the vehicle that communicates directly or indirectly with the charging station to adjust the current and voltage or to terminate the process when a predetermined capacity limit is reached. Power electronics are usually located in the charging station. Since the direct current connections of the charging station are connected directly to the corresponding connections of the traction battery—without a detour through an AC/DC converter of the vehicle-high charging currents can be transmitted with low losses, which enables short charging times.

In one embodiment, the charging station is designed as a charging column. In particular, the charging station has at least one charging point, in particular exactly one charging point or exactly two charging points.

In particular, the charging station is designed as a fast charging station. In one embodiment, the charging station is designed as a battery-supported charging station, in particular as a battery—supported fast charging station.

In the context of the present technical teaching, a load state of the climate conditioning device is understood in particular to mean a thermal load state of the climate conditioning device.

In the context of the present technical teaching, a charging capacity is understood in particular to mean an electrical charging capacity, in particular a charging current and/or a charging voltage, of the charging station.

In the context of the present technical teaching, a climate conditioning device is understood in particular to be an active climate conditioning device, in particular a refrigeration system. The climate conditioning device can be designed as a compression refrigeration machine, an absorption refrigeration machine, an adsorption refrigeration machine, a steam jet refrigeration machine or a refrigeration machine that uses the Joule-Thomson effect.

In one embodiment, the climate conditioning device is designed as a compression refrigeration machine and has a closed refrigerant circuit which-in the specified order in the direction of flow of the refrigerant-has the following refrigeration components: a refrigerant compactor, a condenser, a throttle device or a relief valve and an evaporator. In particular, the climate conditioning device is configured to carry out a thermodynamic cycle process.

In one embodiment, the climate conditioning device is configured to cool a cooling air flow provided for cooling the charging station. In another embodiment, the climate conditioning device is configured to cool a cooling medium circuit provided for cooling the charging station, in particular a cooling water circuit. In yet another embodiment, the climate conditioning device is configured to cool both a cooling air flow provided for cooling the charging station and a cooling medium circuit, in particular a cooling water circuit, also provided for cooling the charging station. In particular, it is possible for the cooling air flow to be used to cool an electrical energy storage system of the charging station, while the cooling media circuit is used to cool the power electronics of the charging station. In a further embodiment, it is provided in particular that the cooling air flow used to cool the electrical energy storage system is cooled directly by the cooling media circuit, wherein the cooling media circuit also cools the power electronics of the charging station directly, and wherein the cooling media circuit itself is recooled by the climate conditioning device. In particular, it is possible for the climate conditioning device to be used exclusively for recooling the cooling medium circuit, wherein the various components of the charging station are cooled directly or indirectly by the cooling medium circuit.

In one embodiment, the load state of the climate conditioning device is determined repeatedly, in particular cyclically, in particular with a predetermined timing, in particular with a frequency of 1 Hz to 10 Hz, particularly preferably 5 Hz, wherein the charging capacity is influenced depending on the load state determined and optionally the further method steps described below are carried out. In particular, the method is thus carried out repeatedly, in particular cyclically, in particular with the predetermined timing, in particular with a frequency of 1 Hz to 10 Hz, particularly preferably 5 Hz.

In one embodiment, the charging capacity is set depending on the determined load state. Alternatively or in addition, the charging capacity is limited depending on the determined load state.

According to a further development of the invention, it is provided that an active charging capacity of the charging station, with which a drive energy storage system of a mobile device, in particular of an electric vehicle, is charged by the charging station, is influenced as the charging capacity. The active charging capacity, in particular the active charging current, a main heat source of the charging station and thus a significant load factor for the climate conditioning device, is advantageously taken into consideration for the avoidance of overload states of the climate conditioning device.

Alternatively or in addition, it is intended that a passive charging capacity of the charging station, with which an electrical energy storage system of the charging station is charged from a power grid, is influenced as the charging capacity. The method can thus also be used in a particularly useful way for charging stations that have an electrical energy storage system-in particular for the intermediate buffering of electrical energy from the power grid, in particular as a “booster” for the active charging capacity-wherein the passive charging capacity, an important heat source and thus also a significant load factor for the climate conditioning device, is taken into consideration for the avoidance of overload states.

In a particularly advantageous embodiment, both the active charging capacity and the passive charging capacity are influenced as charging capacity depending on the determined load state of the climate conditioning device.

According to a further development of the invention, it is provided that a reduction factor is determined depending on the determined load state, wherein the charging capacity is influenced, in particular limited or adjusted, depending on the reduction factor. This represents a particularly simple and efficient design of the method, in particular with regard to the computing effort involved. In an embodiment in which both the active and the passive charging capacity are influenced, a common, i.e. identical, reduction factor can be determined for the active and the passive charging capacity according to a first alternative, or a first reduction factor can be determined for the active charging capacity according to a second alternative, wherein a second reduction factor is determined for the passive charging capacity, wherein the second reduction factor can deviate from the first reduction factor. According to the second alternative, different reduction factors can thus be determined for the active charging capacity on the one hand and for the passive charging capacity on the other.

In particular, the charging capacity is reduced depending on the reduction factor. In one embodiment, the reduction factor is determined from the interval [0,1]. In one embodiment, a nominal charging capacity is multiplied by the difference between the reduction factor and 1 in order to obtain a maximum charging capacity. This means that the maximum charging capacity is effectively reduced if the reduction factor is greater than 0. If the reduction factor is denoted by f, the nominal charging capacity Pₙₒₘ is multiplied by (1-f), resulting in the maximum charging capacity Pₘₐₓ:

$$\\ \begin{matrix}{P}_{max} = ( 1 - f ) {P}_{nom} , & ( 1 )\end{matrix}$$

In this configuration, the current charging capacity of the charging station is limited to the maximum charging capacity Pₘₐₓ and thus dependent on the reduction factor and thus dependent on the determined load state. If the reduction factor f=0, there is effectively no limitation and the current charging capacity can increase to the nominal charging capacity as the maximum charging capacity; if the reduction factor f=1, the charging capacity is limited to zero. If the current charging capacity is lower than the maximum charging capacity, for example due to a corresponding requirement of a device to be charged, such as an electric vehicle to be charged, there is no reducing effect. Thus, at low actual charging capacity, the reduction factor is essentially a measure of the thermal load, and its reducing effect generally only occurs at higher charging capacity.

According to a further embodiment of the invention, it is provided that the load state is determined by comparing at least one load magnitude of the climate conditioning device with a predetermined load magnitude target value which is assigned to the at least one load magnitude. Advantageously, this is a simple and reliable procedure for determining the load state.

According to a further development of the invention, it is provided that the at least one load magnitude is selected from a condenser temperature of the climate conditioning device, a condenser pressure of the climate conditioning device, and a combination of said load magnitudes. Advantageously, the load variables mentioned here are particularly suitable for determining the load state of the climate conditioning device, in particular since all relevant circumstances and also ambient conditions-in particular with regard to re-cooling of the climate conditioning device—are already intrinsically included in these load variables. The load variables mentioned thus take into account in a simple manner both the thermal load of the climate conditioning device and a current recooling capacity, for example due to a temperature difference to the environment.

In the context of the present technical teaching, a condenser temperature is understood in particular to be a temperature that is characteristic of a condensation temperature and/or a condensation pressure of the refrigerant in the condenser of the climate conditioning device. In one embodiment, the condenser temperature can be directly the condensation temperature of the refrigerant in the condenser. In another embodiment, the condenser temperature can, for example, be detected as a temperature of a warm branch of a recooling circuit that is thermally operatively connected to the condenser for recooling, such as a recooling cooling medium circuit, in particular a recooling cooling water circuit. In yet another embodiment, the condenser temperature can be detected upstream or downstream of the condenser in the refrigerant circuit of the climate conditioning device.

In the context of the present technical teaching, a condenser pressure is understood in particular to be a pressure that is characteristic of the condensation pressure and/or the condensation temperature of the refrigerant in the condenser of the climate conditioning device. In one embodiment, the condenser pressure can be directly the condensation pressure of the refrigerant in the condenser. In another embodiment, the condenser pressure can be detected upstream or downstream of the condenser in the refrigerant circuit of the climate conditioning device.

According to a further development of the invention, it is provided that the reduction factor is determined by a controller into which a current value of the at least one load magnitude is input as an actual value and the predetermined load magnitude target value assigned to the at least one load magnitude is input as a target value, wherein the reduction factor is determined, in particular calculated, depending on a control deviation of the actual value from the target value. This allows the reduction factor to be determined in a simple, fast, less computationally intensive and at the same time precise manner.

In one embodiment, an actual condenser pressure, in particular actual condensation pressure, of the climate conditioning device is entered into the controller as the actual value, and a target condenser pressure, in particular target condensation pressure, for the climate conditioning device is entered as the target value.

In one embodiment, a proportional-integral controller (PI controller) is used as the controller for determining the reduction factor.

It is possible that control parameters of the controller can be parameterized by an operator of the charging station. In particular, it is possible that at least one control parameter, selected from a control gain and an reset time, can be set by the operator. In one embodiment in particular, both the control gain and the reset time can be set by the operator.

The condenser pressure, in particular the condensation pressure, can have a permissible value range of 1 bar to 30 bar when using R513a as a refrigerant, for example. In one embodiment, the target condenser pressure, in particular the target condensation pressure, is between 18 bar and 25 bar. Other values may apply or be selected for other refrigerants.

According to a further development of the invention, it is provided that an overload test step is used to check whether an overload state of the climate conditioning device is present, wherein at least one further controllable component of the charging station is operated at least at reduced power-or switched off-if it is determined in the overload test step that an overload state of the climate conditioning device is present. Advantageously, the climate conditioning device can also be relieved quickly and efficiently in this way, in particular by operating other sources of waste heat at reduced power or even switching them off.

In the context of the present technical teaching, an overload state is understood in particular to mean a thermal overload state of the climate conditioning device.

In one embodiment, the at least one further controllable component is selected from a group consisting of: an energy storage system cooling, which is configured to cool the energy storage system of the charging station, a display device, in particular an external display for providing advertising or entertainment content for persons charging at the charging station, a backlight of the display device, and a combination of at least two of the aforementioned controllable components.

According to a further development of the invention, it is provided that in the overload test step it is determined that the overload state is present if the load state-in particular the reduction factor and/or the at least one load magnitude as parameters characteristic of the load state or representing the load state-exceeds a predetermined first load state threshold value, and in addition at least one further heat parameter of the charging station exceeds an assigned first heat parameter threshold value. This approach is based on the idea that one of the parameters mentioned does not necessarily have to be informative on its own: If, for example, the parameter characteristic of the load state exceeds the predetermined first load state threshold value, but at the same time none of the other heat parameters exceeds the assigned first heat parameter threshold value, there is a high thermal load on the climate conditioning device, but this can still be managed, in particular by influencing, in particular limiting, the charging capacity. Conversely, if one of the other heat parameters exceeds the assigned first heat parameter threshold value, but the parameter characteristic of the load state does not exceed the predetermined first load state threshold value, there is-as yet-no thermal overload state despite the high temperature.

In particular, the overload test step checks whether the load state or one of the parameters characteristic of the load state exceeds the predetermined first load state threshold value and whether, in addition, the at least one further heat parameter of the charging station exceeds the assigned first heat parameter threshold value.

In one embodiment, the overload test step checks whether-and it is determined that the overload state is present if-the load state or one of the parameters characteristic of the load state exceeds the predetermined first load state threshold value, and in addition at least two further heat parameters, in particular all further heat parameters, of the charging station exceed the respectively assigned first heat parameter threshold value.

According to a further development of the invention, it is provided that in the overload test step it is determined that there is no overload state if the load state-in particular the reduction factor and/or the at least one load magnitude as the parameters characteristic of the load state or representing the load state-falls below a predetermined second load state threshold value, and in addition the at least one further heat parameter falls below an assigned second heat parameter threshold value.

In particular, the overload test step checks whether the load state or one of the parameters characteristic of the load state falls below the predetermined second load state threshold value, and whether, in addition, the at least one further heat parameter of the charging station falls below the assigned second heat parameter threshold value.

In one embodiment, the overload test step checks whether-and it is determined that there is no overload state if-the load state or one of the parameters characteristic of the load state falls below the predetermined second load state threshold value, and in addition at least two further heat parameters, in particular all further heat parameters, of the charging station fall below the respectively assigned second heat parameter threshold value.

In one embodiment, the predetermined first load state threshold value is greater than the predetermined second load state threshold value. Alternatively or in addition, the first heat parameter threshold values are each greater than the assigned second heat parameter threshold values. This results in a hysteresis in the determination of the overload state.

In particular, in one embodiment, the predetermined second load state threshold value is equal to the predetermined first load state threshold value minus a load state hysteresis value. Alternatively or in addition, the first heat parameter threshold values are each equal to the assigned second heat parameter threshold values minus the respectively assigned heat parameter hysteresis values.

In another embodiment, the predetermined first load state threshold value is equal to the predetermined second load state threshold value. Alternatively or in addition, the first and second heat parameter threshold values assigned to each other are respectively the same.

According to a further development of the invention, it is provided that the at least one further heat parameter is selected from a group consisting of: an energy storage system temperature of the electrical energy storage system of the charging station, a cooling medium temperature of a cooling medium of the cooling medium circuit, and a combination of said heat parameters. These heat parameters are respectively characteristic of the overall thermal load occurring in the charging station and are thus also relevant for assessing the presence of an overload state.

The cooling medium is in particular the cooling medium circulating in the cooling medium circuit provided for cooling the charging station, in particular cooling water, optionally in combination with an antifreeze agent, in particular glycol. In particular, the cooling medium is different from the refrigerant used in the thermodynamic cycle process of the climate conditioning device. In one embodiment, a cooling medium tank temperature in a cooling medium tank, in particular a water tank, is detected as the cooling medium temperature, wherein the cooling medium tank serves in particular as a storage and/or buffer vessel for the cooling medium circuit and in particular is integrated into the cooling medium circuit. The cooling medium tank temperature is thus characteristic of the temperature of the cooling medium circuit and thus of the thermal load in the cooling medium circuit.

In one embodiment, the overload test step determines that the overload state exists when the reduction factor exceeds the predetermined first load state threshold, and in addition the energy storage system temperature and the cooling media temperature exceed their respectively assigned first heat parameter thresholds.

Alternatively or in addition, the overload test step determines that the overload state is not present if the reduction factor falls below the predetermined first load state threshold value minus the load state hysteresis value, and in addition the energy storage system temperature and the cooling media temperature fall below their respectively assigned first heat parameter threshold values minus the respective heat parameter hysteresis value.

For example, the energy storage system temperature can have a permissible value range of −20° C. to 45° C. The cooling medium temperature, in particular the cooling medium tank temperature, can have a permissible value range of −20° C. to 35° C.

In one embodiment, the predetermined first load state threshold is between 0.3 and 0.6. Alternatively or in addition, the predetermined second load state threshold value is between 0.1 and 0.4. Alternatively or in addition, the load state hysteresis value is between 0.2 and 0.6, in particular up to 0.3.

Alternatively or in addition, the first heat parameter threshold value assigned to the energy storage system temperature is between 30° C. and 40°° C. Alternatively or in addition, the second heat parameter threshold value assigned to the energy storage system temperature is between 25° C. and 35° C. Alternatively or in addition, the heat parameter hysteresis value assigned to the energy storage system temperature is between 5° C. and 15° C.

Further alternatively or in addition, the first heat parameter threshold value assigned to the cooling medium temperature, in particular the cooling medium tank temperature, is between 28° C. and 35° C. Alternatively or in addition, the second heat parameter threshold value assigned to the cooling medium temperature, in particular the cooling medium tank temperature, is between 20° C. and 30° C. Alternatively or in addition, the heat parameter hysteresis value assigned to the cooling medium temperature, in particular the cooling medium tank temperature, is from 5° C. and 15° C.

According to a further embodiment of the invention, it is provided that the climate conditioning device is operated in a switch-off mode when a switch-off condition is fulfilled.

In the context of the present technical teaching, operating the climate conditioning device in switch-off mode means in particular that the compressor of the climate conditioning device is switched off.

In one embodiment, the switch-off condition is fulfilled in particular if the load state, in particular the at least one load magnitude and/or the reduction factor, exceeds a predetermined switch-off threshold.

In one embodiment, the predetermined switch-off threshold is different from the predetermined first load state threshold value, in particular the predetermined switch-off threshold is greater than the predetermined first load state threshold value.

In one embodiment, the switch-off condition is no longer fulfilled, in particular the climate conditioning device is no longer operated in the switch-off mode, if the load state, in particular the at least one load magnitude and/or the reduction factor, falls below the predetermined switch-off threshold-optionally minus a switch-off hysteresis value. In particular, the compressor is restarted when it is determined that the predetermined switch-off threshold-optionally minus the switch-off hysteresis value-is no longer exceeded.

The predetermined switch-off threshold can be between 0.5 and 0.8 in particular. The switch-off hysteresis value can be between 0.4 and 0.8, in particular between 0.5 and 0.7.

In one embodiment, a separate switch-off test step, in particular outside the other method steps and/or independent of the other method steps in terms of time, checks whether the switch-off condition is present, i.e. whether the load state, in particular the at least one load magnitude and/or the reduction factor, exceeds the predetermined switch-off threshold or falls below the predetermined switch-off threshold-optionally minus a switch-off hysteresis value. The separate switch-off test step is carried out repeatedly, in particular cyclically, in particular with a predetermined timing, in particular with a frequency of between 1 Hz and 10 Hz, particularly preferably 5 Hz.

In one embodiment, the reduction factor is kept constant in the switch-off mode.

In a further embodiment-in particular in addition-the charging station continues to be operated with the reduction factor kept constant even when switch-off mode is ended.

In this case, operation continues with the reduction factor kept constant, in particular until the reduction factor is redetermined, or for a predetermined period of time.

According to a further embodiment of the invention, it is provided that, if it is determined in the overload test step that an overload state is present, it is checked-in particular in a cooling switch-off test step-whether the cooling medium temperature of the cooling medium of the cooling medium circuit, in particular the cooling medium tank temperature, exceeds a predetermined cooling switch-off limit value, wherein an energy storage system cooling of an electrical energy storage system of the charging station is switched off if the cooling medium temperature exceeds the predetermined cooling switch-off limit value, in particular if it is determined in the cooling switch-off test step that the cooling medium temperature exceeds the predetermined cooling switch-off limit value.

In the context of the present technical teaching, switching off the energy storage system cooling of the electrical energy storage system means in particular that at least one fan, which is configured to generate the cooling air flow for cooling the energy storage system, is switched off.

According to a further development of the invention, it is provided that the energy storage system cooling is activated when the cooling medium temperature corresponds at most to the predetermined cooling switch-off limit value.

In the context of the present technical teaching, activating the energy storage system cooling means in particular that the at least one fan is switched on to generate the cooling air flow.

In one embodiment, the cooling switch-off limit value is between 20° C. and 25° C.

The invention also comprises a computer program comprising instructions which, when the computer program is executed by a computing device, in particular a control device for operating a charging station, cause the computing device to carry out the method according to the invention or a method according to one of the previously described embodiments.

The object is also solved by creating a control device for operating a charging station, in particular for electric vehicles, which is configured to carry out the method according to the invention or a method according to one or more of the embodiments described above. In connection with the control device, the advantages already explained in connection with the method apply in particular.

Finally, the object is also solved by creating a charging station, in particular for electric vehicles, which has a control device according to the invention or a control device according to one or more of the embodiments described above. In connection with the charging station, the advantages already explained in connection with the method or the charging station apply in particular.

In particular, the charging station has at least one feature that was previously described explicitly or implicitly in connection with the method as a feature of the charging station, in particular a combination of such features. In this respect, reference is made to the previous description of the charging station given in connection with the method.

In particular, the control device is operatively connected to the climate conditioning device of the charging station to control said climate conditioning device. Furthermore, the control device is operatively connected in particular to the power electronics of the charging station to control said power electronics. Optionally, the control device is operatively connected to a cooling device, in particular to a cooling media circuit, of the charging station to control said cooling device.

The invention is explained in more detail below with reference to the drawing. The Figures show:

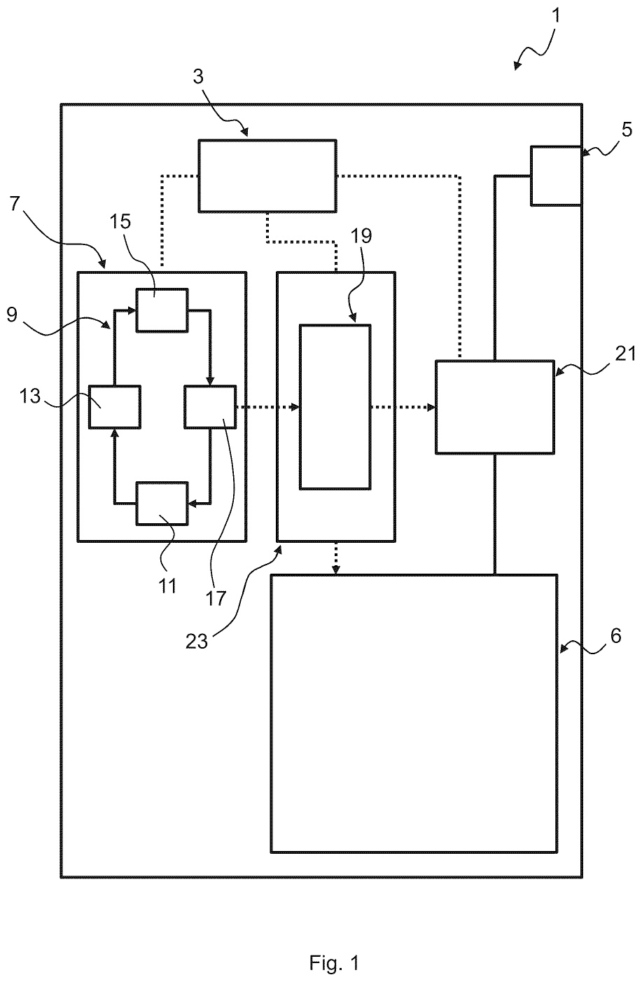

FIG. 1 shows a schematic representation of an embodiment example of a charging station with an embodiment of a control device, and

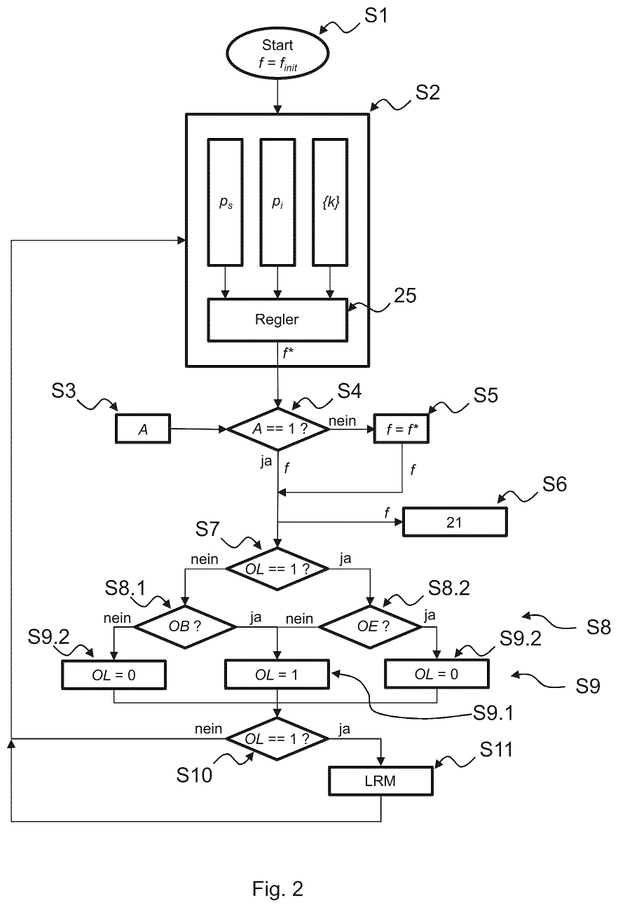

FIG. 2 shows a schematic representation of an embodiment example of a method for operating the charging station.

FIG. 1 shows a schematic representation of an embodiment example of a charging station 1, in particular for electric vehicles, with an embodiment example of a control device 3.

The charging station 1 has at least one charging point 5, wherein respectively one electric vehicle, for example, can be charged at each charging point 5. In addition, the charging station 1 has an electrical energy storage system 6 for the intermediate storage of electrical energy for charging electric vehicles in particular. The charging station 1 can be connected to a power grid, wherein the electrical energy storage system 6 is regularly charged from the power grid; however, it can also be designed as a mobile charging station 1 which can be operated independently of a power grid, wherein the electrical energy storage system 6 is then only recharged sporadically, in particular when required.

The charging station also has a climate conditioning device 7, which is designed here as a compression refrigeration machine for carrying out a thermodynamic cycle process. It has a closed refrigerant circuit 9, which has the following refrigeration components-in the specified order in the direction of flow of the refrigerant: a refrigerant compactor 11, a condenser 13, a throttling device 15 and an evaporator 17.

In particular, the climate conditioning device 7 is configured to recool a cooling medium circuit 19 provided for cooling the charging station 1, in particular a cooling water circuit. The cooling media circuit 19 in turn preferably cools power electronics 21 of the charging station 1 directly and also a cooling air flow, wherein in particular the electrical energy storage system 6 of the charging station 1 is cooled by means of the cooling air flow.

The cooling media circuit 19 is in particular part of a cooling device 23 which, in addition to the cooling media circuit 19, can also include fans, for example, in particular a fan for generating the cooling air flow.

The control device 3 is configured in particular to carry out a method described in more detail below.

As part of the method, a load state of a climate conditioning device 7 is determined, and a charging capacity of the charging station 1 is influenced, in particular limited or set, depending on the load state determined.

Preferably, the load state of the climate conditioning device 7 is determined repeatedly, in particular cyclically, in particular with a predetermined timing, in particular with a frequency between 1 Hz and 10 Hz, particularly preferably 5 Hz, wherein the charging capacity is influenced depending on the load state determined and optionally the further method steps described below are carried out.

FIG. 2 shows a schematic representation of an embodiment example of the method for operating the charging station 1.

Identical and functionally identical elements are provided with the same reference numbers in all Figures, so that reference is made to the previous description in each case.

The embodiment example of the method shown here starts in a first step S1, in which a reduction factor f is initialized with an initialization value fᵢₙᵢₜ, for example fᵢₙᵢₜ=0.

In a second step S2, the load state of the climate conditioning device 7 is determined, and a current value f* for the reduction factor f is determined depending on the determined load state.

The load state is determined by comparing at least one load magnitude of the climate conditioning device 7 with a predetermined load magnitude target value that is assigned to the at least one load magnitude. In the embodiment example shown here, an actual condenser pressure pi of the climate conditioning device 7 is used as the at least one load magnitude, and a target condenser pressure pₛ is used as the predetermined load magnitude target value. In particular, the condensation pressure of the refrigerant in the condenser 13 is measured and used as the actual condenser pressure pi.

The current value f* of the reduction factor is determined by a controller 25, in particular a PI controller, into which the actual condenser pressure pᵢ is entered as the actual value and the target condenser pressure pₛ as the target value, wherein the current value f* of the reduction factor is calculated depending on a control deviation of the actual value from the target value and, in particular, depending on control parameters {k}—such as a control gain and a reset time. The current value f* of the reduction factor assumes values from the interval [0,1] in particular.

In a third step S3, which can be carried out separately—i.e. in particular independently of time-from the rest of the method, and which is also referred to as the switch-off test step, it is checked whether a switch-off condition for a switch-off operation of the climate conditioning device 7 is present.

In particular, the switch-off condition checks whether the current value f* of the reduction factor exceeds a predetermined switch-off threshold, in which case the switch-off condition is fulfilled. It is also checked whether the current value f* of the reduction factor falls below the predetermined switch-off threshold—optionally minus a switch-off hysteresis value—in which case the switch-off condition is no longer fulfilled. If the current value f* exceeds the predetermined switch-off threshold, a logical switch-off variable A is assigned the value 1 and the compressor 11 is switched off or—if it is already switched off—is not switched on again; if the current value f* falls below the predetermined switch-off threshold-optionally minus the switch-off hysteresis value—the switch-off variable A is assigned the value 0 and the compressor 11 is either not switched off or—if it is switched off-is switched on. Optionally, no new value is assigned to the switch-off variable A in the hysteresis range between the predetermined switch-off threshold minus the switch-off hysteresis value and the predetermined switch-off threshold, i.e. it retains the previously assigned value. Another option is that, starting from the value 1, the switch-off variable is only assigned the value 0 again when a predetermined period of time has elapsed since the switch-off condition was first no longer fulfilled. Alternatively, starting from the value 1, the switch-off variable A is only assigned the value 0 again when the current value f* of the reduction factor changes.

In the context of the present technical teaching, the values 0 and 1 are always used in connection with logical variables, which in this respect correspond to the logical values “false” (0) and “true” (1). However, these values can also be represented in any other way without substantially changing the method. The only important thing is that a logical variable can have two different discrete values.

In a fourth step S4, the system checks whether the value of the switch-off variable is equal to 1. If this is the case, the reduction factor f retains its last assigned value, i.e. the last assigned value is not replaced by the current value f*, but rather the current value f* is preferentially discarded. If, on the other hand, the value of the switch-off variable is not equal to 1, i.e. is in particular equal to 0, the current value f* is assigned to the reduction factor f in a fifth step S5, i.e. the last assigned value is replaced by the current value f*.

In a sixth step S6, a maximum charging capacity Pₘₐₓ of the charging station 1 is reduced depending on the reduction factor f, in particular the maximum charging capacity Pₘₐₓ is calculated according to equation (1) as the product of a nominal charging capacity Pₙₒₘ with (1-f).

The charging capacity can be an active charging capacity, with which, for example, the drive energy storage system of the electric vehicle is charged by the charging station 1, and/or a passive charging capacity, with which the electrical energy storage system 6 is charged from a power grid.

In a seventh step S7, it is checked whether a logical overload variable OL has the value 1. If this is not the case, a first eighth sub-step S8.1 of an eighth step S8, which is also referred to as an overload test step, checks whether a start condition OB for an overload state of the climate conditioning device 7 is present. This is the case if the reduction factor f exceeds a predetermined first load state threshold value and, in addition, an energy storage system temperature of the electrical energy storage system 6 and a cooling medium temperature of the cooling medium circuit 19 exceed respectively assigned first heat parameter threshold values. In this case, in a first ninth sub-step S9.1 of a ninth step S9, the logical overload variable OL is assigned the value 1. Otherwise, if the start condition OB in the first eighth sub-step S8.1 is not fulfilled, the value 0 is assigned to the logical overload variable OL in a second ninth sub-step S9.2 of the ninth step S9.

If it is determined in the seventh step S7 that the logical overload variable OL has the value 1, it is checked in a second eighth sub-step S8.2 of the eighth step S8 whether an end condition OE exists for the overload state. This is the case if the reduction factor f falls below a second load state threshold value, in particular the predetermined first load state threshold value minus the load state hysteresis value, and in addition the energy storage system temperature and the cooling medium temperature fall below respectively assigned second heat parameter threshold values, in particular their respectively assigned first heat parameter threshold values minus the respective heat parameter hysteresis value. In this case, in the second ninth sub-step S9.2 of the ninth step S9, the logical overload variable OL is assigned the value 0. Otherwise, if the end condition OE is not fulfilled in the second eighth sub-step S8.2, the value 1 is assigned to the logical overload variable OL in the first ninth sub-step S9.1 of the ninth step S9, or-with an equivalent result-this value is retained.

Preferably, the predetermined first load state threshold value is greater than the predetermined second load state threshold value-in particular by the load state hysteresis value. In addition, the first heat parameter threshold values are preferably each greater-in particular by the respective heat parameter hysteresis value-than the assigned second heat parameter threshold values. Furthermore, the predetermined switch-off threshold is preferably greater than the predetermined first load state threshold value.

In a tenth step S10, the system then checks again whether the logical overload variable OL has the value 1. If this is the case and there is thus an overload state, at least one load-reducing measure LRM is initiated in an eleventh step S11, i.e. at least one further controllable component of the charging station 1 is operated at least with reduced power-or switched off. The at least one further controllable component can be selected from a group consisting of: an energy storage system cooling, which is configured to cool the energy storage system 6, a display device, in particular an external display for providing advertising or entertainment content for persons charging devices such as electric vehicles at the charging station 1, a backlight of the display device, and a combination of at least two of the aforementioned controllable components.

Preferably, the eleventh step S11 checks whether the cooling media temperature exceeds a predetermined cooling switch-off limit value, wherein an energy storage system cooling of the electrical energy storage system 6 is switched off if the cooling media temperature exceeds the predetermined cooling switch-off limit value. In particular, a fan which is configured to generate the cooling air flow for cooling the energy storage system 6 is then switched off.

The energy storage system cooling is preferably reactivated, i.e. the fan is switched on again when the cooling medium temperature corresponds at most to the predetermined cooling switch-off limit value, i.e. in particular is less than or equal to the predetermined cooling switch-off limit value.

After the eleventh step S11, the method is preferably continued again in the second step S2.

If it is determined in the tenth step S10 that the logical overload variable OL does not have the value 1, i.e. in particular that it has the value 0, the method is preferably continued directly in the second step S2, in particular without load-reducing measures. It is possible that in this case, before returning to the second step S2, previously initiated load-reducing measures LRM are reversed if needed.

In particular, the method is thus carried out repeatedly, in particular cyclically, in particular with the predetermined timing, in particular with a frequency of 1 Hz to 10 Hz, particularly preferably 5 Hz.

1. A method for operating a charging station (1), in particular for electric vehicles, wherein
a load state of a climate conditioning device (7) of the charging station (1) is determined, and wherein
a charging capacity of the charging station (1) is influenced depending on the determined load state.

2. The method according to claim 1, wherein as the charging capacity
an active charging capacity of the charging station, with which a drive energy storage system of a mobile device, in particular of an electric vehicle, is charged by the charging station, and/or
a passive charging capacity of the charging station, with which an electrical energy storage system of the charging station is charged from a power grid, is influenced.

3. The method according to claim 1, wherein a reduction factor is determined depending on the determined load state, wherein the charging capacity is influenced, in particular limited or adjusted, depending on the reduction factor.

4. The method according to claim 1, wherein the load state is determined by comparing at least one load magnitude of the climate conditioning device with a predetermined load magnitude target value that is assigned to the at least one load magnitude.

5. The method according to claim 1, wherein the at least one load magnitude is selected from a condenser temperature of the climate conditioning device, a condenser pressure of the climate conditioning device, and a combination of said load magnitudes.

6. The method according to claim 1, wherein the reduction factor is determined by a controller into which a current value of the at least one load magnitude is input as an actual value and the predetermined load magnitude target value assigned to the at least one load magnitude is input as a target value, wherein the reduction factor is determined, in particular calculated, depending on a control deviation of the actual value from the target value.

7. The method according to-one of the preceding claims claim 1, wherein in an overload test step it is checked whether an overload state of the climate conditioning device is present, wherein at least one further controllable component of the charging station is operated at least at reduced power if it is determined in the overload test step that an overload state of the climate conditioning device is present.

8. The method according to claim 7, wherein in the overload test step it is determined that the overload state is present if
the load state, in particular the reduction factor, exceeds a predetermined first load state threshold value, and in addition
at least one further heat parameter of the charging station exceeds an assigned first heat parameter threshold value.

9. The method according to claim 7, wherein in the overload test step it is determined that no overload state is present if
the load state, in particular the reduction factor, falls below a predetermined second load state threshold value, and in addition
the at least one further heat parameter falls below an assigned second heat parameter threshold value.

10. The method according to claim 1, wherein the at least one further heat parameter is selected from a group consisting of:
an energy storage system temperature of an electrical energy storage system of the charging station, a cooling medium temperature of a cooling medium of the cooling medium circuit, and a combination of said heat parameters.

11. The method according to claim 1, wherein the climate conditioning device is operated in a switch-off mode when a switch-off condition is fulfilled, wherein preferably the reduction factor is kept constant in the switch-off mode, and wherein further preferably the charging station continues to be operated with the reduction factor kept constant even when the switch-off mode is ended, in particular until the reduction factor is redetermined.

12. The method according to claim 1, wherein, if it is determined in the overload test step that an overload state is present, it is checked whether a cooling medium temperature of the cooling medium of a cooling medium circuit exceeds a predetermined cooling switch-off limit value, wherein an energy storage system cooling of an electrical energy storage system of the charging station is switched off if the cooling medium temperature exceeds the predetermined cooling switch-off limit value.

13. The method according to claim 1, wherein the energy storage system cooling is activated when the cooling medium temperature corresponds at most to the predetermined cooling switch-off limit value.

14. A control device for operating a charging station, in particular for electric vehicles, wherein the control device is configured to carry out a method according to claim 1.

15. A charging station, in particular for electric vehicles, having a control device according to claim 14.
